(19) United States
(12) Patent Application Publication
(10) Pub. No.: US 2009/0254325 A1
(43) Pub. Date: Oct. 8, 2009

(54) MANAGEMENT OF MEASUREMENT DATA BEING APPLIED TO RESERVOIR MODELS

(76) Inventors: Oktay Metin Gokdemir, Houston, TX (US); Christopher Mair, Edinburgh (GB)

Correspondence Address: CAROL WILSON;BP AMERICA INC., MAIL CODE 5 EAST, 4101 WINFIELD ROAD, WARRENVILLE, IL, 60555, US

(21) Appl. No.: 12/406,372

(22) Filed: Mar. 18, 2009

Related U.S. Application Data
(60) Provisional application No. 61/038,146, filed on Mar. 20, 2008.

(51) Int. Cl. G06G 7/48

(52) U.S. Cl. 703/10

(57) ABSTRACT

A data management toolkit for acquiring measurement data regarding hydrocarbon wells and reservoirs, from a database, and processing that data for application to a reservoir model. The data management toolkit is implemented as a web-based application, accessible from remote workstations. The reservoir engineer configures the data management toolkit to acquire measurement data and previously calculated parameter values over a date range, for one or more wells, and also specifies various processing options including filtering, averaging, and the like. Events, such as RFT tests and pressure build-up analyses, may also be included. The web-based data management toolkit is executed on a web server to acquire and process that data, and to then update model files accordingly.

### CROSS-REFERENCE TO RELATED APPLICATIONS

This application claims priority, under 35 U.S.C. §119(e), of Provisional Application No. 61/038,146, filed Mar. 20, 2008, incorporated herein by this reference.

### STATEMENT REGARDING FEDERALLY SPONSORED RESEARCH OR DEVELOPMENT

Not applicable.

### BACKGROUND OF THE INVENTION

This invention is in the field of oil and natural gas production, and is more specifically directed to reservoir management and well management in such production.

Current economic factors in the oil and gas industry have raised the stakes in the optimization of hydrocarbon production. On one side of the equation, the market prices of oil and natural gas are currently high by historical standards. However, the costs of drilling of new wells and operating existing wells are also high by historical standards, because of the extreme depths to which new producing wells must be drilled and because of other physical barriers to exploiting reservoirs. These higher economic stakes require production operators to devote substantial resources toward gathering and analyzing measurements from existing hydrocarbon wells and reservoirs in the management of production fields and of individual wells within a given field.

For example, the optimization of production from a given field or reservoir involves decisions regarding the number and placement of wells, including whether to add or shut-in wells. Secondary and tertiary recovery operations, for example involving the injection of water or gas into the reservoir, require decisions regarding whether to initiate or cease such operations, and also how many wells are to serve as injection wells and their locations in the field. Some wells may require well treatment, such as fracturing of the wellbore if drilling and production activity has packed the wellbore surface sufficiently to slow or stop production. In some cases, production may be improved by shutting-in one or more wells; in other situations, a well may have to be shut-in for an extended period of time, in which case optimization of production may require a reconfiguration of the production field. As evident from these examples, the optimization of a production field is a complex problem, involving many variables and presenting many choices.

In recent years, advances have been made in improving the measurement and analysis of parameters involved in oil and gas production, with the goal of improving production decisions. For example, surface pressure gauges and flow meters deployed at the wellhead, and also in surface lines interconnecting wellheads with centralized processing facilities, are now commonly monitored. These gauges and meters are also used with separating equipment, to measure the flow of each phase (oil, gas, water). Because these sensors can provide data on virtually a continuous basis, an overwhelming amount of measurement data can rapidly be obtained from a modern complex production field.

Of course, a primary purpose of acquiring measurements from wells in a production field is to use such data in deciding how best to maximize production from the reservoir. These decisions depend, in large part, on the validity of estimates of the size, shape, and static and dynamic properties of the reservoir itself. Determination of these reservoir estimates is typically a very complex problem, given the difficulty with which modern reservoirs are modeled. The complexity of this problem is exacerbated by the scale of modern large oil and gas production fields, which often include hundreds of wells and a complex network of surface lines that interconnect these wells with centralized processing facilities. These operations are made significantly more complex by variations in well maturity over a large number of wells in the production field, in combination with finite secondary and tertiary recovery resources. These factors all add up to create a very complex and difficult optimization problem for the reservoir engineering staff. Especially in the later life operation of the production field, the decisions for optimum production and economic return become extremely complex. But, as mentioned above, the economic stakes are high.

As mentioned above, a vast amount of measurement data can now be acquired in modern production fields. While such a quantity and timeliness of measurement data can, of course, greatly improve the accuracy with which a reservoir can be characterized over time, this large quantity of data can overwhelm the reservoir engineer.

This difficulty is exacerbated by the nature of current-day tools for dealing with this overwhelming amount of reservoir data. It has been observed, in connection with this invention, that the operations required of the reservoir engineer to apply well and reservoir measurements to an existing reservoir model, using conventional data processing operations and tools, lead to a very cumbersome and tedious task. FIGS. 1a and 1b illustrate an example of the operations required of a reservoir engineer to apply recent well or reservoir measurements to an existing reservoir model, using conventional data management tools in a conventional architecture.

In the conventional example of FIG. 1 a, well or reservoir measurements are received by the reservoir engineer from one or more conventional data sources in data servers 2, in the format or formats produced by those data sources. As shown in the architecture of FIG. 1b, the reservoir engineer accesses those data sources from his or her workstation 3, by way of a conventional network or communications link to one or more of data servers 2, which is in communication with a database DB within which the measurement data are stored. These measurement data can include oil, gas, and water flow rates, calculated productivity index data, reservoir pressures, and the like from one or more wells. Examples of databases DB accessible by data servers 2 that store these measurement data include SQL databases, proprietary databases for generating and storing calculated parameters such as productivity index (PI) and reservoir pressure, and the like; as mentioned above, these data may be measurement data stored within databases DB, or alternatively may be values calculated by one or more various applications. In this conventional approach, the human reservoir engineer (user) operates workstation 3 to execute one or more “macros” to load one or more data files from data servers 2 into spreadsheet files, such as .xls files generated by the EXCEL spreadsheet program available from Microsoft Corporation, operating locally on the user's workstation 3. Users of the EXCEL program will readily recognize that several steps are involved in the acquisition of data from a text file or other data source, including selecting whether the data are comma-delimited, tab-delimited, etc.; in addition, other operations may be required in order to arrange the data in the databases retrieved from data servers 2 in a form that is acceptable by one of the EXCEL or other macros used in process 4. The output of process 4 is one or more. .xls files produced by the EXCEL program at workstation 3; as known in the art, often some amount of further editing of the imported data while in this .xls file format may also be required.

Next, the user is faced with the converting of this data into a file format suitable for importing into a reservoir simulation program, in process 8. In the example of FIG. 1, one such reservoir simulation program is the VIP DATA STUDIO program, which is part of the VIP reservoir simulation software suite available from Halliburton, and which is also executing locally at user workstation 3. As such, the user executes process 8 to convert the data in the .xls file produced in process 6 into a VIP-compatible file 10 (e.g., a “.pa” file), which the user then imports into the VIP DATA STUDIO program at workstation 3, in process 12. As known in the art, the VIP DATA STUDIO program produces output 14 according to two file types, one being an “.obs” file containing data corresponding to rates, pressures, and other time-dependent measurements and parameters, and the other being an “r.dat” file for recurrent data such as Repeat Formation Tester (RFT) measurements, pressure build-up (PBU) analyses, and the like. These files are resident at workstation 3, in the architecture of FIG. 1b. The output of the VIP DATA STUDIO program is often applied to larger scale modeling and data management programs, for example the TOP-DOWN RESERVOIR MODELLING (or “TDRM”) toolkit used by British Petroleum, for example as described in Williams et al., “Top-Down Reservoir Modeling”, SPE Paper 89974 (Society of Petroleum Engineers, 2004), incorporated herein by this reference. In this instance, yet another editing process 16 is performed by the user, at workstation 3, in order to render the VIP files 14 in the proper form for application to the TDRM reservoir modeling toolkit. Following process 16, therefore, the user applies edited output files 18 to a well model such as the TDRM reservoir modeling toolkit, executing at workstation 3 itself or on a remote server or mainframe 7 as shown in FIG. 1b.

This sequence of operations described above in connection with FIGS. 1a and 1b is typical of the workflow required in order to apply well and reservoir measurement data to a useful reservoir model, such as the TDRM models for the particular reservoir. As is evident from this description, the human user, typically a reservoir engineer, must perform several manual steps to convert the measurement data and results from one format to another. Considering the large amount of measurement data that is generated from an operating reservoir over time, it will be apparent to those skilled in the art having reference to this specification that the workload involved in applying measurement data to a reservoir model is not only tremendous, but quite tedious.

Furthermore, there are certain steps in this overall workflow in which the reservoir engineer must make certain judgments about the data. For example, transient events such as shut-ins, bean-ups (gradual increases as a well is brought to producing from shut-in), and well or sensor failures must be dealt with, in either including or excluding such measurements from the longer-term reservoir modeling process. Accordingly, the reservoir engineer typically applies some amount of data filtering to include or exclude transient excursions not reflective of the long-term performance of the reservoir, commonly referred to as “spikes”, in the measurements, or alternatively to spread out the effect of such spikes over multiple wells in such a manner that material balance over the reservoir is maintained. Low flow rate measurements or calculations that are not reflective of the long-term performance of the reservoir, for example as due to a well being shut-in for some reason, may also be present in the measurement data. The human reservoir engineer must decide how low a rate must be in order to be ignored for a given well, and also whether and the extent to which the effects of a low flow rate at one well are to be spread out over nearby wells in the reservoir, again to maintain material balance over the reservoir. These and other decisions are made by the individual reservoir engineer, locally at workstation 3, as he or she carries out the workflow illustrated in FIG. 1a, such decisions being made.

However, because these decisions and judgments involved in processing the data are made by the individual reservoir engineer, substantial variations in the reservoir model output that are not due to changes in the reservoir can result. For example, a reservoir engineer may process the measurement data in FIG. 1a differently at one time relative to another. Personnel may also change over time, with different personnel applying different filtering and data treatment judgment as compared with one another. In addition, different personnel may be processing data from different portions of the reservoir at the same time (as shown by other users 7, each operating a workstation linked to data servers 2 and mainframe 5 as shown), or may even be processing the same data yet obtaining different results. Furthermore, often the selection of the various parameters applied to the data, such as the level at which low flow rate processing is triggered, are somewhat arbitrary on the part of the reservoir engineer; however, inconsistencies in these parameters can lead to variations in the ultimate modeling result. These variations in data handling may be reflected in the reservoir modeling results—such that decisions may be made based on apparent shifts in the reservoir resulting from these artifacts in processing, rather than from an actual physical change at the reservoir.

The processing of reservoir measurement data, and the applying of these data to reservoir models, is therefore not only tedious according to conventional methods, but is also prone to error and imprecision.

As described above, the manual operations involved in FIG. 1a are typically performed locally at the reservoir engineer's workstation 3, in which case the reservoir engineer must make the connection to the one or more various data servers 2 to retrieve the data. This localized processing by the reservoir engineer serves to ensure that decisions made in filtering and processing the measurement data are stored only locally, at the engineer's workstation 3, and may not be accessible to downstream or parallel users 7, or subsequent recipients of the reservoir modeling results, such as economists or managers, called upon to make or verify decisions regarding the continued exploitation of the reservoir being modeled. The configuration decisions and inputs involved in this conventional manual processing must therefore be obtained by other means, if at all.

### BRIEF SUMMARY OF THE INVENTION

Embodiments of this invention provide a system and method that streamlines the application of measurement data regarding wells and reservoirs to reservoir models.

Embodiments of this invention provide such a system and method that results in consistent application of these measurement data to the reservoir models over time, despite changes in reservoir engineering personnel or location.

Embodiments of this invention provide such a system and method that streamlines data access to the measurement data and the model files.

Embodiments of this invention provide such a system and method that improves the throughput of reservoir model updating, and the quantity of measurement data applied to the models, and thus improve the accuracy of the model results.

Embodiments of this invention provide such a system and method of applying measurement data to reservoir models without requiring the invocation of external applications to update simulation models.

Embodiments of this invention provide such a system and method that is able to acquire data from a wide range of data sources.

Embodiments of this invention provide such a system and method that applies variable averaging to the measurement data to reduce the quantity of measurement data applied to the reservoir models over long update periods.

Embodiments of this invention also provide objects and advantages that will be apparent to those of ordinary skill in the art having reference to the following specification together with its drawings.

An embodiment of this invention may be implemented by way of a web-based data management application for extracting measurement data from various data sources, applying transformations, and validations to that data according to connection parameters stored at the server at which the web-based application is executing. The web-based application, invoked by the reservoir engineer from a workstation, enables the reservoir engineer to locally build, visualize, and display the results of, queries used to generate the transformed data. The processed measurement data are then applied to the desired reservoir model from the web-based application.

### BRIEF DESCRIPTION OF THE SEVERAL VIEWS OF THE DRAWING

FIG. 1a is a data flow diagram illustrating a conventional workflow for applying well and reservoir measurement data and calculations to a reservoir model.

FIG. 1b is a schematic block diagram illustrating the system network architecture for carrying out the conventional workflow of FIG. 1a.

FIG. 2 is a schematic diagram illustrating the measurement and analysis system of an embodiment of the invention as deployed in a oil and gas production field.

FIG. 3 is a schematic block diagram illustrating a system network architecture for carrying out a workflow according to that embodiment of the invention.

FIG. 4 is a data flow diagram illustrating the workflow according to that embodiment of the invention.

FIG. 5 is a workflow diagram illustrating the operation of the workflow according to that embodiment of the invention.

FIGS. 6 and 7a through 7d are flow diagrams illustrating the operation of the workflow of FIGS. 4 and 5 according to that embodiment of the invention.

FIG. 8 is a data flow diagram illustrating the interactive use of the reservoir modeling results according to that embodiment of the invention.

FIG. 9 is a flow diagram illustrating the periodic invocation of the method of FIGS. 4 and 5 according to that embodiment of the invention.

FIG. 10 is a data flow diagram illustrating a workflow according to an alternative embodiment of the invention.

### DETAILED DESCRIPTION OF THE INVENTION

This invention will be described in connection with one or more of its embodiments, namely as implemented into a corporate architecture by way of which producing oil and gas reservoirs are being managed based on recent measurements and observations regarding the wells in those reservoirs, and the reservoirs themselves. This example is provided because it is contemplated that this invention will be especially beneficial when deployed in such an environment. However, it is also contemplated that this invention may also provide important benefits in streamlining and making consistent data acquisition and application in other applications. Accordingly, it is to be understood that the following description is provided by way of example only, and is not intended to limit the true scope of this invention as claimed.

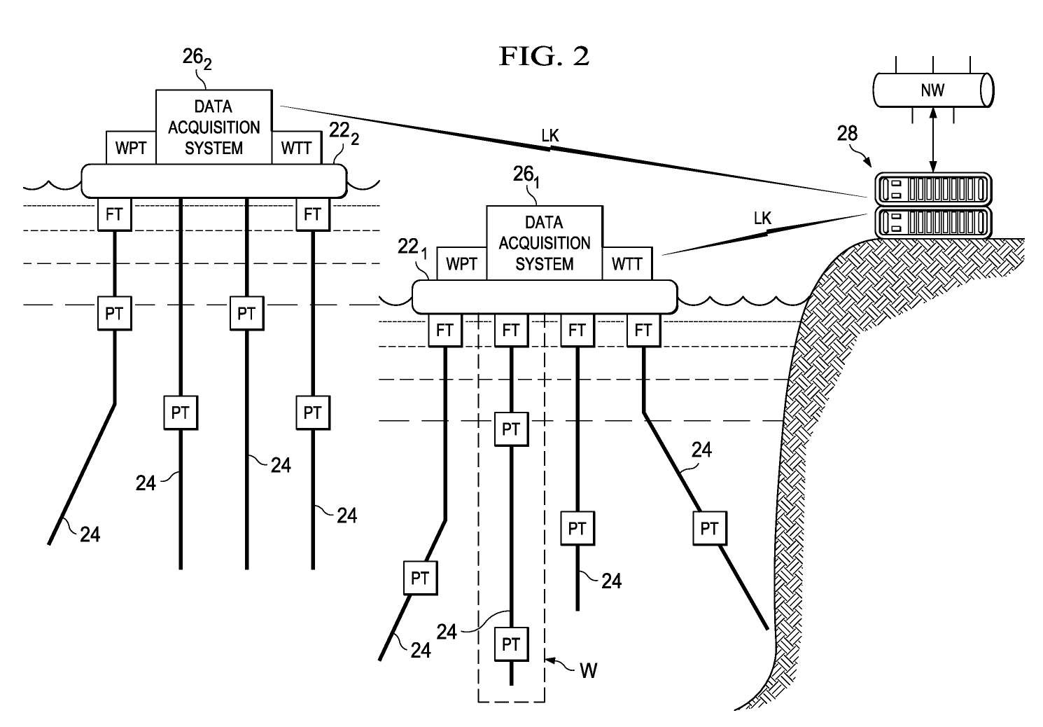

FIG. 2 illustrates an example of the implementation of an embodiment of the invention as realized in an offshore oil and gas production field. In this example, two offshore drilling and production platforms 22₁, 22₂ are shown as deployed; of course, typically more than two such platforms 22 may be used in a modern offshore production field. Each of platforms 22₁, 22₂ support one or more wells W, shown by completion strings 24 supported by platforms 22₁ and 22₂. Of course, more or fewer than four completion strings 24 may be supported by a single platform 22, as known in the art. A given completion string 24 and its associated equipment, including pressure transducers PT, flow transducers FT, and the like, will be referred to in this description as a well, and example of which is well W indicated in FIG. 2.

According to this embodiment of the invention, one or more pressure transducers or sensors PT is deployed within each completion string 24. Pressure transducers PT are contemplated to be of conventional design and construction, and suitable for downhole installation and use during production. Examples of modern pressure transducers PT suitable for use in connection with this invention include those available from Quartzdyne, Inc., among others available in the industry.

In addition, as shown in FIG. 2, conventional wellhead pressure transducers WPT are also deployed at the wellheads at platforms 22. Wellhead pressure transducers WPT sense pressure at the wellhead, typically at the output of multiple wells after the flows are combined, although individual wellhead pressure transducers WPT may alternatively be dedicated to individual wells W. FIG. 2 also illustrates conventional wellhead temperature transducers WTT, which sense the temperature of the fluid output from the wells W served by a given platform 22, also at the wellhead; again, wellhead temperature transducers WTT may serve individual wells W at platform 22, if so deployed.

It is contemplated that other downhole and wellhead sensors may be deployed for individual wells, or at platforms or other locations in the production field, as desired for use in connection with this embodiment of the invention. For example, downhole temperature sensors may also be implemented if desired. In addition, not all wells W may have all of the sensor and telemetry of other wells W in a production field, or even at the same platform 22. Furthermore, injecting wells W will typically not utilize downhole pressure transducers PT, as known in the art.

Platforms 22₁, 22₂ are each equipped with a corresponding data acquisition system 26₁, 26₂. Data acquisition systems 26 are conventional computing and processing systems for deployment at the production location, and that manage the acquisition of measurements from downhole pressure transducers PT, as well as from other measurement equipment and sensors at platforms 22 and in connection with the completion strings 24 at that platform 22, such as flow transducers FT. Data acquisition systems 26 also manage the communication of those measurements to shore-bound server 28, in this embodiment of the invention, such communications being carried out over a conventional wireless or wired communications link LK. In addition, data acquisition systems 26 each are capable of receiving control signals from server 28, for management of the acquisition of additional measurements, calibration of its sensors, and the like. Data acquisition systems 26 may apply rudimentary signal processing to the measured signals, such processing including data formatting, time stamps, and perhaps basic filtering of the measurements, although it is preferred that the bulk of the filtering and outlier detection and determination is to be carried out at server 28.

Server 28, in this example, is a shore-bound computing system that receives communications from multiple platforms 22 in the production field, and that can operate to carry out the analysis of the downhole pressure measurements. Server 28 can be implemented according to conventional server or computing architectures, as suitable for the particular implementation. In this regard, server 28 can be deployed at a large data center, or alternatively as part of a distributed architecture closer to the production field. Server 28 is also connected to a conventional local area or wide area network NW, by way of which the data acquired and processed by server 28 can be accessed and processed according to this embodiment of the invention, as will be described in further detail below.

While the implementation of this embodiment of the invention illustrated in FIG. 2 is described relative to an offshore production field environment, those skilled in the art having reference to this specification will readily recognize that this invention is also applicable to the management of terrestrial hydrocarbon production fields, and of individual wells and groups of wells in such land-based production. Of course, in such land-based oil and gas production, the wells and their completion strings are not platform-based. As such, each well or completion string may have its own data acquisition system 26 for communication of its transducer measurements to server 28; alternatively, a data acquisition system may be deployed near multiple wells in the field, and as such can manage the communication of measurements from those multiple wells in similar fashion as the platform-based data acquisition systems 26 of FIG. 2.

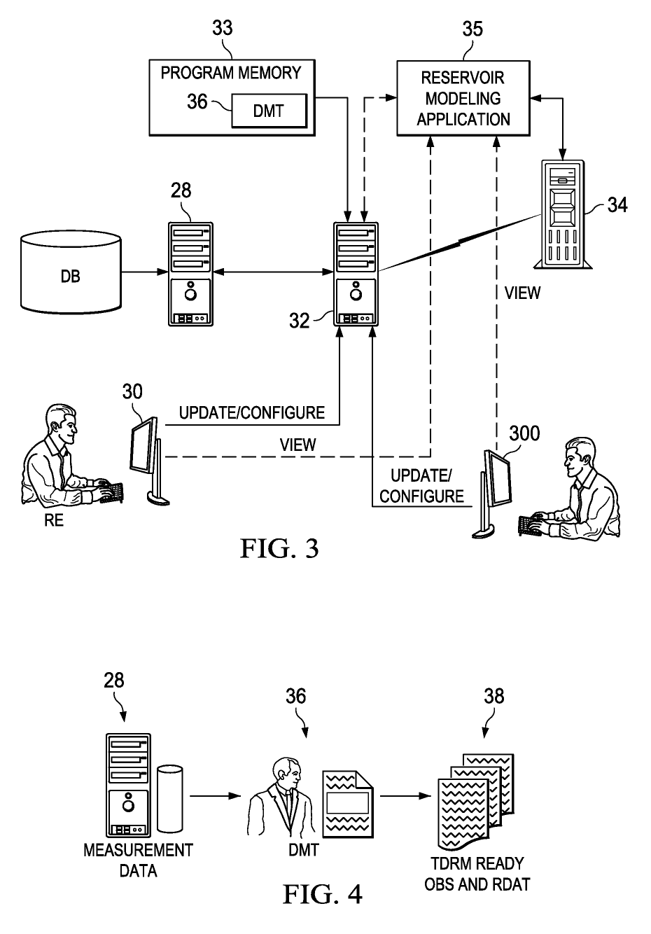

FIG. 3 illustrates an architecture implementing a system and method for applying well and reservoir measurement data and calculated parameters to a reservoir model, according to an embodiment of the invention. Workstation 30 is a local workstation or personal computer with the conventional capability of receiving and sending data, executing software programs, processing data, and the like, and which has a visual display or other output device for presenting output in graphical or alphanumeric form; according to this embodiment of the invention, workstation 30 is programmed or otherwise operable to carry out the functions described in this specification, among others. According to this architecture, workstation 30 can be physically or virtually manned by a human user or expert, such as reservoir engineer RE in this illustration, and provides access to the corporate network or other wide area network in the conventional manner. Reservoir engineer RE in this example is contemplated to correspond to one or more individuals having the training or expertise to interpret or recognize reservoir information and data; as such, the term reservoir engineer RE as used in this specification also refers to technicians, operators, statisticians, mathematicians, geologists, scientists, and other types of engineers, as well as those specifically referred to as reservoir engineers. According to this embodiment of the invention, this network provides the ability for workstation 30 to communicate with web server 32, under the direction of reservoir engineer RE. As evident from the architecture diagram of FIG. 3 and as will be evident from the following description, web server 32 executes much of the processing involved in the functions of this system.

Web server 32, in this specification, refers to a conventional computer system capable of supporting web services and web-based applications, whether accessible via the Internet or by way of a local area network or another type of wide area network, private (e.g., “intranet”) or public. As known in the art, web server 32 may be realized as a computer program that, when executed on such a computer system, accepts HTTP requests from clients (e.g., user agents such as web browsers, whether running on the same computer system or on a different physical computer and in communication with web server 32 over a network), and serves HTTP responses to the requesting clients, such as web pages in the form of HTML documents and linked objects. Examples of web server application programs known in the art include the INTERNET INFORMATION SERVER (“IIS”) computer program available from Microsoft Corporation, and the HTTP SERVER computer program available from The Apache Software Foundation. This web server application program may be running on a computer system dedicated to this function; alternatively, the web server application program may be executing on a computer system used for other functions, and indeed may be executing on workstation 30 itself. It is contemplated that any reasonably capable modern web server hardware and the corresponding web server software will be suitable for use as web server 32, with the particular capacity as may be required for its particular implementation in the overall network. Among its other components, web server 32 preferably includes one or more CPU cores, co-processing circuitry, and the like for executing software routines that are stored in its program memory 33 or otherwise accessible to web server 32. Program memory 33 may be realized by conventional mass storage memory resources, and may in fact be combined with data memory (including, perhaps, the very databases storing the measurement data) within the same physical resource and memory address space, depending on the architecture of web server 32. In the example shown in FIG. 3, web server 32 is a separate computer system that is accessible to workstation 30 and other workstations 300 via conventional network interface circuitry and infrastructure. Ultimately, web server 32 may be realized by many variations and alternative architectures, including both centrally-located and distributed architectures.

In this regard, web server 32 is able to access data servers 28 that access the various databases DB storing measurement data acquired from wells W via data acquisition systems 26 (FIG. 2), as well as previously calculated parameters for those wells W and the corresponding reservoir. In addition, web server 32 can also access and obtain data stored in “flat” files such as .xls files, or text files such as ASCII files, stored on other remote servers or workstations 30, 300 that are accessible to web server 32 over the network or over other communication links. As mentioned above, it is contemplated that data servers 28 and web server 32 could be realized in the same physical computer system, although it is further contemplated that these servers 28, 32, will typically be realized in separate (often physically distant) hardware systems, interconnected by way of a conventional network or other communications link.

In this architecture illustrated in FIG. 3, web server 32 is also capable of accessing or communicating with reservoir modeling application 35. It is contemplated that reservoir modeling application 35 will typically reside on and be executed by a separate computing system, for example mainframe computer 34 deployed at the same or different physical location as web server 32, with which web server 32 is in communication via a conventional network or communications link. Alternatively, as suggested in FIG. 3, reservoir modeling application 35 may reside on and be executed by web server 32 itself, if web server 32 has sufficient computational capacity and if the architect of this system chooses to arrange the system architecture in that manner. Further in the alternative, reservoir modeling application 35 may reside and be executed on workstation 30 itself.

In the arrangement of FIG. 3, according to this embodiment of the invention, commands from reservoir engineer RE are executed by workstation 30 to communicate configuration parameters, and update commands and parameters, to web server 32. These parameters and commands are used by web server 32 in its execution of program instructions for carrying out the method of this embodiment of the invention, such program instructions corresponding to data management toolkit application (DMT) 36, shown in FIG. 3 as stored in program memory 33. In this embodiment of the invention, DMT application 36 is a web-based application, in that its functions are accessed via a web browser client application, typically via a network such as the Internet or an intranet, and as such is contemplated to be coded in a browser-compatible language such as HTML or Java. DMT application 36 may alternatively be otherwise accessible to web server 32, for example residing elsewhere on a local area network or wide area network and communicated to web server 32 by way of encoded information on an electromagnetic carrier signal. As noted above, if workstation 30 itself is executing the software of web server 32, DMT application 36 may reside in program memory 33 of workstation 30 itself, for execution by workstation 30. In the execution of those program instructions, web server 32 will access one or more appropriate database DB via data servers 28, in this example, to obtain measurement data and calculations for processing by web server 32 according to this embodiment of the invention. Web server 32 will communicate these data and calculations after such processing by mainframe computer 34 in its execution of reservoir modeling application 35 (or, alternatively, will provide those processed data and calculations to reservoir modeling application 35 if web server 32 is itself executing that application). Via conventional network communications, workstations 30, 300 can then view the results of reservoir modeling application 35 to which the processed data and calculations are applied by web server 32, as shown in FIG. 3.

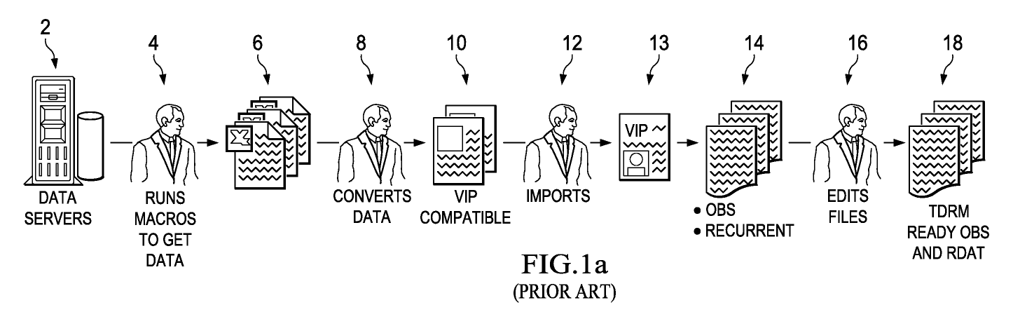

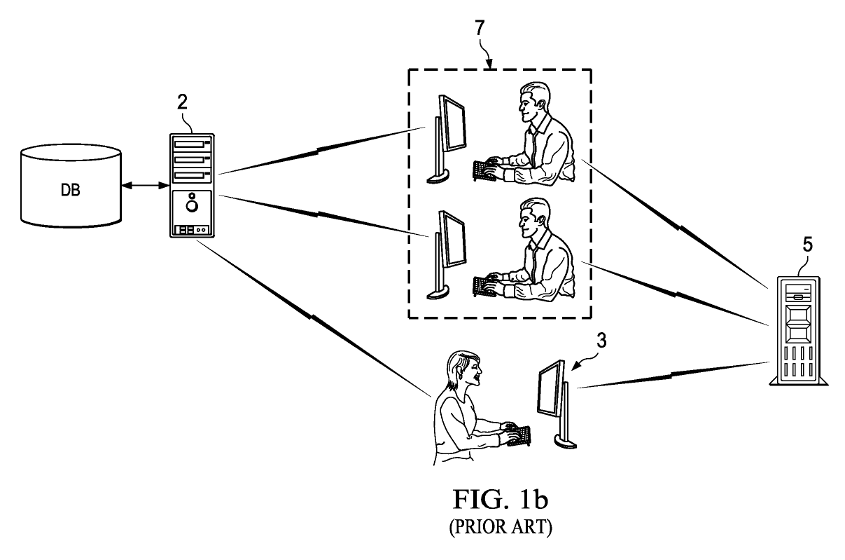

The architecture of the system and method according to this embodiment of the invention is thus radically different from the conventional system architecture according to which reservoir engineers previously processed and applied measurement data to reservoir modeling applications. As shown in FIG. 1b, the local workstation 3 of the reservoir engineer would itself communicate with data servers 2, to retrieve the measurement data from the corresponding database; this local workstation 3 would be used by the reservoir engineer to manually process, transform, and format those measurement data, for example in the manner described above relative to FIG. 1a. The results of that processing at local workstation 3 would then be forwarded to mainframe 5 for execution of the reservoir modeling software. As evident from a comparison of this conventional approach of FIG. 1b with the architecture of the embodiment of the invention as shown in FIG. 3, implementation of the data processing as a web-based application at web server 32 streamlines and coordinates access to data servers 28 and to mainframe 34 or such other computing resources executing reservoir modeling application 35. In addition, as will become apparent from the following description, the architecture of FIG. 3 facilitates persistent storage of the processing parameters, file names and mappings, and other decisions made by reservoir engineer RE in configuring the manner in which the measurement data are applied to reservoir modeling application 35, thus improving the consistency of the reservoir modeling results over time, and among different reservoir engineering personnel.

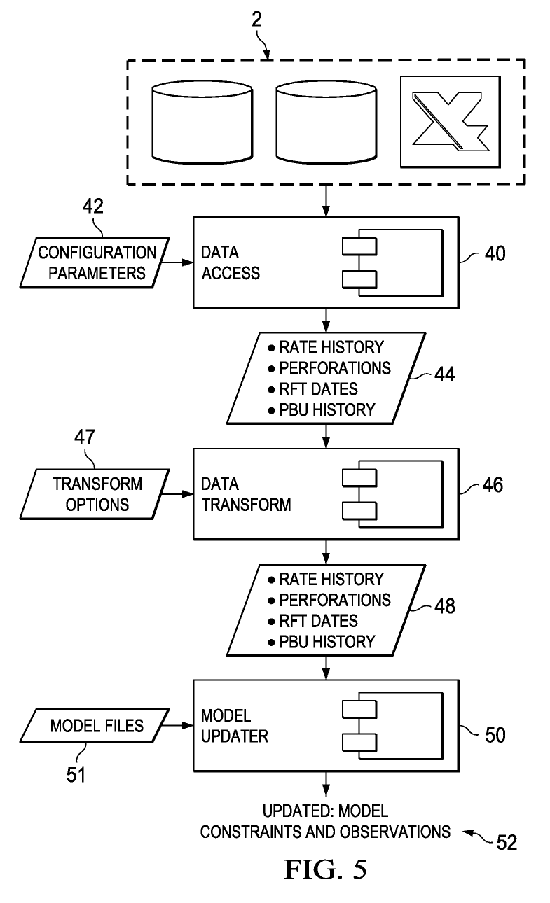

The architecture of FIG. 3, and the operation of the method and system according to this embodiment of the invention, as will be described below, greatly streamlines the workflow by way of which reservoir engineers acquire and apply measurement data and other calculations to reservoir modeling software suites. This streamlined workflow is illustrated schematically in FIG. 4. As evident in FIG. 4, DMT application 36 acquires measurement data and previously calculated results from data servers 28, and processes those data into a format 38 that is suitable for application to the desired reservoir modeling application 35 (FIG. 3). The reservoir engineer or other human user interfaces with DMT application 36, which is a web-based application as shown in FIG. 3. The workload on this reservoir engineer in so processing these data is greatly reduced from that in conventional application of measurement data to reservoir models, as discussed above in FIG. 1a; in addition, the measurement data accessed via data servers 28 may be in a wide variety of formats and forms, according to this embodiment of the invention, yet readily processed by DMT application 36, as will be described below.

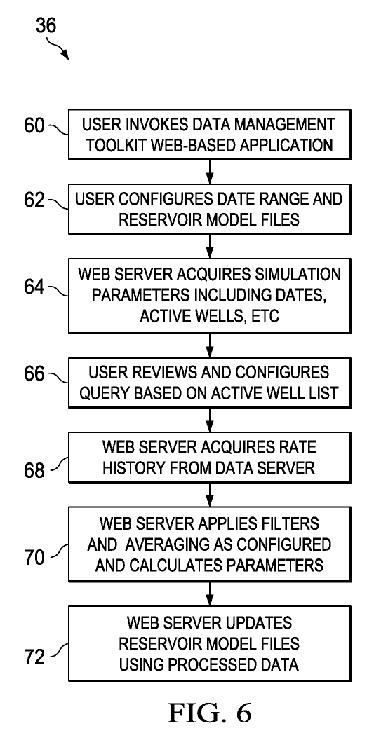

FIG. 5 illustrates, in further detail, the workflow and thus the software and operational architecture of DMT application 36 according to the embodiment of the invention. This workflow is illustrated by way of various software components 40, 46, 50 that make up at least some of DMT application 36, and that reside at and are executed by web server 32 of FIG. 3. As known in the art, relative to workflow diagrams such as that shown in FIG. 5, each software component receives input data, and processes that input data, according to various options provided to the component or otherwise set by the user or originator, to produce output data. These components 40, 46, 50 conform to software interfaces that the overall workflow of DMT application 36 expects for abstracted activities, such as data access, data transformations, data validation, and model updates. These components 40, 46, 50 are preferably implemented by way of “plug-in” components, such that different or modified components can be derived and used without necessarily disrupting the overall DMT application 36 or the other components; indeed, it is contemplated that these plug-in components 40, 46, 50 can be replaced at run time, without requiring redevelopment of the overall code. In addition, this framework enables the use of several components of each type in series. The workflow of FIG. 5 is not intended to necessarily represent a sequential temporal flow of inputs, processes, and outputs, but rather is intended to reflect the overall architecture by way of which DMT application 36 is constructed and operates.

As shown in FIG. 5, data access component 40 of DMT application 36 receives, as its inputs, measurement data and previously calculated parameters from one or more data sources 2. It is contemplated that these input data sources 2 may store data in a wide range of various formats, each of which can be accessed by data access component 40 according to this embodiment of the invention. Examples of these input data formats include SQL database format; proprietary or publicly-available special formats such as those produced by the rate and phase calculation software program and system (“ISIS”) described in copending application Ser. No. 12/035,209, filed Feb. 21, 2008, commonly assigned with this application and incorporated herein by this reference; previously derived “observation files” in the .obs format useful by the VIP DATA STUDIO software program and suite discussed above; text files; and spreadsheet files such as .xls or .xlsx files produced by spreadsheet programs such as the EXCEL spreadsheet program available from Microsoft Corporation. It is contemplated that other input data formats may also be accessible by data access component 40 of DMT application 36, depending on the particular construction and intended use of DMT application 36. For example, it is contemplated that data access component 40 can use web services (not shown) that can access and provide data for processing by DMT application 36. As such, it is contemplated that data sources 2 can constitute a wide range of measurement data and previously calculated parameters, including rate and phase information for one or more wells in the reservoir; measured pressures from wellbores or wellheads and in the production lines; calculated reservoir pressure values; well perforation times and measurements; data applied to and results of other analytical tools; pressure build-up (PBU) test measurements and results; results output from reservoir and well models; and other sources of pertinent data.

Data access component 40 also receives processing options in the form of connection parameters 42 selected and input by reservoir engineer RE via workstation 30. These connection parameters include a definition of the update period over which the acquired measurement data is to correspond; mapping of various columns, tags, keys, or fields in the database being accessed to columns, tags, keys, or fields in the output from the data access; whether flow rate measurements or calculations are to be constrained to one phase or taken cumulatively over all phases (gas, oil, condensate); whether the time variable over the acquired data is to be considered as logarithmic or linear; and the like. The detailed interaction between reservoir engineer RE and data access component 40, as part of DMT application 36, will be described in further detail below.

Upon selection and definition of data sources 2 from which the measurement data are to be acquired, and the various connection parameters 42 defined by reservoir engineer RE, data access component 40 interrogates databases DB via data servers 28 (FIG. 4) to access data sources 2, and to acquire the desired measurement data and calculated parameters. Output data 44 from data access component 40, in the workflow of FIG. 5, constitutes a rate history for one or more wells for which measurement data were acquired, along with indications of perforations, dates of RFT data acquisition, and pressure build-up test (PBU) history corresponding to the time period of interest. Data 44 are not directly applicable to reservoir modeling application 35 at this stage, however. Rather, these data 44 are transformed by data transform component 46, according to various transform options 47 selected and indicated by reservoir engineer RE via workstation 30.

According to this embodiment of the invention, these transform options 47 provided by reservoir engineer RE include selection of filters, if any, that are to be applied to the acquired data, and configuration of the selected filters. Examples of specific filters that are useful in connection with well and reservoir measurement data and calculations include “spike” filters, in which measurements or parameters that appear to be excursions from a longer-term normal trend, whether reflecting abnormally high or abnormally low values relative to that trend, are filtered. The behavior of the selected spike filter in identifying these excursions is configurable via transform options 47. For example, a “spike” can be defined, in transform options 47, as a measurement value that is larger than a selected deviation (defined as a percentage deviation, as an absolute deviation value, or defined in statistical terms) from the maximum of a range of previous measurement values, for example the range of measurement values occurring within a specified date window; in this case, reservoir engineer RE can set the “look-back” date window and the threshold deviation for the filter in transform options 47. The identified excursions or spikes are then processed by the filter, also according to the filter configuration specified in transform options 47. For example, the identified spike measurements may simply be ignored or excluded from the measurement data. Alternatively, the filter may spread the identified spikes, for example over time or over multiple wells, in order to maintain material balance. Similarly, a “low flow rate” filter may also be selected and configured by reservoir engineer RE via transform options 47, by setting a low flow rate threshold level, below which readings from one or more wells are ignored, or the effects spread over time or multiple wells for material balance purposes, also as specified in transform options 47. Similarly, a “pressure change” filter may be selected and configured, by way of which one or more wells that appear to be undergoing a pressure change may be ignored, or the corresponding data otherwise handled, also in a manner that is configurable via transform options 47. In each of these cases, the particular parameters within configuration options 47 that define the behavior of these and other similar filters are within the judgment of the engineering staff, and as such these parameters can vary among reservoirs and production fields, among wells within a production field, and among operators. However, DMT application 36 according to this embodiment of the invention provides reservoir engineer RE with visibility into nominal values for such filters, and also with the ability to set different values for such parameters according to his or her judgment.

Transform options 47 may also include selection and configuration of an averaging approach to be applied to one or more of the measurements or parameters to be acquired. Modem well measurement technology now involves sensors that are capable of high frequency (>1 Hz) measurements of various well parameters. Of course, if the update period for which data are to be acquired is relatively long (e.g., weeks or months), these high frequency measurements can result in a massive data file to be processed by web server 32, even though minor variations in the measured parameter are irrelevant from the standpoint of reservoir modeling application 35. As such, one or more parameters may be selected for “averaging” by way of transform options 47, such that measurement data or calculations that are available on a high frequency basis can be first averaged over a specified period (e.g., daily, weekly, monthly) in producing the data that are applied to reservoir modeling application 35. The configuration of such averaging can differ among different parameters, and over time if desired.

Furthermore, transform options 47 may include text and data input by reservoir engineer RE regarding various events, known by reservoir engineer RE from other information sources or personal knowledge, occurring in the reservoir in the time period of interest. These events can include perforations, RFT tests and the resulting data, pressure build-up events and the resulting pressure derivatives, and other generic or non-categorized events. It is contemplated that transform options 47 may simply include a textual description of each such event, along with a timestamp indicating the date and time at which the event occurred. Furthermore, it is also contemplated that numerical data corresponding to the event may also be entered, each data point or group of points associated with a timestamp, by way of these transform options 47. Examples of such numerical data include wellbore pressure derivative values over time, such as are produced during a pressure build-up (PBU) event.

Transform option 47 may also include the configuration of calculations for one or more of the measurements or parameters for simulation wells that are not explicitly represented in databases DB. For example, measurements from wells that produce from, or inject to, multiple layers in the earth include measurements, such as pressure, that correspond to conditions at those various layers. However, these multiple-layer wells are usually represented as a single well in databases DB, because the simulation approach to be applied these wells may require that each of the multiple layers accessed by the same well each be treated as a single well. Under these circumstances, a one-to-one mapping of one or more of the measurements or parameters from database DB to the simulation is not appropriate. Rather, the simulation well values are recalculated based on a time-dependent linear transformation, using coefficients input by reservoir engineer RE via transform options 47, and the corresponding measurement data stored in databases DB for the specified time periods. Reservoir engineer RE may adjust these transformation coefficients over time for a given well, via transform options 47. This transformation recasts the measurement data for the multiple-layer wells into measurement data for individual single wells, each producing from or injecting into a single layer.

Using these transform options 47, data transform component 46 processes data 44 into output data 48, which also contains rate history data, and indications of perforations, dates of RFT data acquisition, and pressure build-up test (PBU) history corresponding to the time period of interest, but having been processed with the filtering, averaging, and event information indicated by transform options 47.

Processed data 48 are then applied to the desired reservoir models by model updater component 50. Options 51 defined by reservoir engineer RE include identification of the specific model files (the “.obs” and “r.dat” files, for TDRM or VIP modeling suites; or the appropriate format (e.g., “*.fcs” files) for application to the NEXUS integrated reservoir simulation software available from Landmark, a division of Halliburton) for the reservoir under investigation. The TDRM modeling suite is described in Williams et al., “Top-Down Reservoir Modeling”, SPE Paper 89974 (Society of Petroleum Engineers, 2004), incorporated herein by this reference. These options 51 also include identification of the specific wells for which updated measurements are to be applied in those models, and which model parameters are to be updated. Model updater component 50 then applies the processed measurement and calculation and other data 48 to the specified model files, in the specified manner. Reservoir modeling application 35 is now available to be invoked and executed, for viewing by reservoir engineer RE or other personnel.

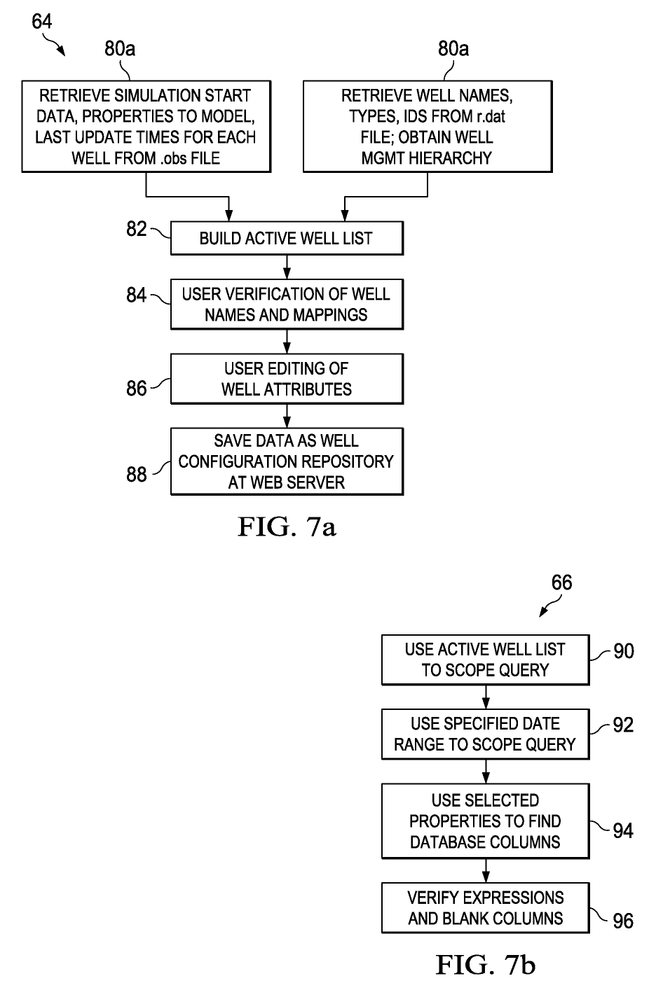

Given this overview of the overall workflow, by way of the diagram of FIG. 5, a more detailed description of the overall operation of the methodology reflected in that software architecture will now be provided, with reference to FIGS. 6 and 7a through 7d. It is contemplated that those skilled in the art having reference to this specification will be readily able to derive and produce the corresponding computer software and instructions, without undue experimentation, from the foregoing description as well as the more detailed description now to be provided.

The operation of DMT application 36 according to this embodiment of the invention begins with the user, e.g., reservoir engineer RE, operating workstation 30 to invoke the execution of DMT application 36, in process 60. As described above, DMT application 36 is preferably a web-based application, residing on and executable by, web server 32. Process 60 is therefore preferably performed by workstation 30 accessing a web service supported by web server 32, for example by way of a website address or the like, in which user inputs at workstation 30 can initiate the execution of DMT application 36, from program memory 33 of web server 32, by web server 32. DMT application 36 is then loaded into memory of web server 32, and execution of its main routine begins. As typical of web-based applications, while the application itself (DMT application 36) is executed by web server 32, its graphics and interactive output is presented by way of a website or other window appearing at the invoking workstation 30.

In process 62, reservoir engineer 32 next interacts with DMT application 36 via workstation 30 to provide configuration inputs and parameters to DMT application 36. These configuration inputs and parameters include configuration inputs corresponding to options for one or more of components 40, 46, 50, described above relative to the workflow and architecture illustrated in FIG. 5. As described above, these parameters and inputs configure the tasks to be performed by DMT application 36 in acquiring and processing measurement data and calculations from databases DB, and in applying the processed data and calculations to reservoir modeling application 35. In this process 62, reservoir engineer RE enters the range of dates from which measurement data and calculated parameters are to be acquired, and enters the reservoir model files (for TDRM and VIP modeling suites, the “.obs” and “r.dat” file specifications; for the NEXUS reservoir simulation software, the “*.fcs” and associated data file specifications) to which the acquired and processed measurement data and parameters are to be applied.

Process 64 is now executed by web server 32, in response to the configuration inputs provided by reservoir engineer RE in process 62. In a general sense, process 64 acquires the simulation parameters to be used in the execution of reservoir modeling application 35. FIG. 7a illustrates the operations of process 64 in further detail. As discussed above, reservoir engineer RE specified the particular model files (.obs and r.dat files) that are to be updated with the data and parameters to be acquired. In process 80a, web server 32 interrogates the specified observations file (“.obs”) to retrieve the start date at which associated simulations are to start, as will be useful for pressure build-up derivative values, to retrieve the properties of interest that are to be modeled for the wells and reservoirs, and also the times at which each of the wells indicated in the model were each last updated in the model. In process 80b, web server interrogates the recurrent data (“r.dat”) file specified in process 62 to acquire a list of the well names associated with the model and the modeled reservoir, and various identification for those wells including simulation IDs for those wells in that model, and connected node IDs for purposes of connectivity modeling. In addition, a well management hierarchy is obtained from this recurrent data file, according to which the topology of the interconnection of wells in the reservoir with their associated gathering stations, and the topology of the interconnection of the gathering stations with higher levels of nodes, is characterized.

Upon obtaining this information, web server 32 then builds an “active well list” of the wells that are relevant to the reservoir model of the .obs and r.dat files, in process 82. This active well list is preferably derived by web server 32 comparing the last update times of the wells in the model, and selecting those wells with the most recent updates. This active well list assigns names to each of the wells, each well receiving a “simulation name” for purposes of the simulation carried out by reservoir management application 35, and a “data source” name that web server 32 retrieves from a well configuration repository in its memory resources; if a well with a simulation name is not listed in the well configuration repository, the simulation name is assigned to that well as a default data source name for the well. Process 84 is then executed, by way of which web server 32 presents a graphical user interface display to reservoir engineer RE at workstation 30 with the names for each of the wells in the simulation. In process 84, reservoir engineer RE in turn verifies the well names in the list, confirming which wells are to be included in the updated model, and also verifies the “mappings” in the active well list so that, for each well, its data source name in the active well list matches the name for that well in the data source 2 that is to be accessed, and so that its simulation name in the active well list corresponds to the correct well in the simulation. For example, these mappings associate columns in SQL source databases with columns in the eventual output data files (.obs and r.dat), and associate tags in other source databases (such as the ISIS data files produced by the system and software described in copending application Ser. No. 12/035,209 incorporated by reference above) with columns in the eventual output data files.

Web server 32 next, in process 86, presents a graphical user interface (GUI) by way of which the wells in the active well list are presented to reservoir engineer RE on workstation 30. This active well list is presented in a sorted order, for example according to a sort order established in the well management hierarchy that sorts the wells first by their active status, then by well type, and finally by simulation name. This list of wells is presented in an interactive fashion at workstation 30, so that reservoir engineer RE can edit any of the attributes for each of the wells in the active well list, in process 86. Upon completion of editing process 86, web server 32 then saves the edited active well list as an updated well configuration repository in its memory resources, in process 88.

Referring back to FIG. 6, process 66 is next executed by web server 32, by way of which reservoir engineer RE is presented with the edited active well list generated in process 86, at workstation 30. In process 66, shown in more detail in FIG. 7b, reservoir engineer RE uses this active well list to scope an SQL query, in process 90. Process 90 scopes the eventual query by selecting the wells and well attributes for which data are to be acquired from data sources 2. In process 92, reservoir engineer RE further scopes the data range of the SQL query, starting with the data range originally configured in process 62. In process 94, web server 32 presents reservoir engineer RE with a list of the properties of interest, for the wells in the active well list; reservoir engineer RE consults an catalog of these well properties maintained by web server 32 to find column names in the source database corresponding to the properties of interest, and correlates these column names and properties as desired. In process 96, the query is completed by reservoir engineer RE ensuring that any expressions and blank column names in the query are handled properly. The database query to be applied to data sources 2 is now configured, completing process 66.

Web server 32 then accesses data servers 28, in process 68, to acquire measurement data and calculated parameters from the associated data sources 2 corresponding to the query that was configured in process 66. FIG. 7c illustrates acquisition process 68 in further detail, beginning with process 98 in which web server 32 makes an entry into a log database indicating the timestamp of the query, the name and IP address of reservoir engineer RE requesting the query and update, specification of the configuration of the query itself, and the destination model files. Such a log database may be useful in subsequent analysis and updating of the same model files. In process 100, data servers 28 are accessed by web server 32 with the configured query, in the form of an SQL command, and the data corresponding to that query are forwarded by data servers 28 to web server 32. In process 102, web server 32 processes the received data into a historical dataset, preferably with one data table associated with each well in the query. In process 104, web server 32 analyzes the data tables in the historical data set now generated to the list of properties of interest contained in the configured query. Any missing properties for a given well are updated by evaluating a corresponding expression or formula, using historical data or data newly retrieved in connection with the current query. Examples of properties that are typically missing and that are typically evaluated in this fashion include gas/oil ratio (GOR), and cumulative oil production (COP). The inputs and configuration parameters applied by reservoir engineer RE up to this stage of the process generally correspond to the options applied to data access component 40 in the workflow and architecture illustrated in FIG. 5; an exception to this is the indication of the reservoir model files (.obs and r.dat) that are specified in process 62 (FIG. 6). After process 68, the rate history and other measurement data and calculated parameters have been retrieved by web server 32 and are ready for additional processing. This additional processing is performed in process 70, which will be described in detail relative to FIG. 7d.

In process 106, process 70 begins with the retrieval of the historical data set by web server 32, which will serve as the input to the data processing and transformation (corresponding to component 46 of FIG. 5). In process 108, web server 32 transforms the data in this historical data set according to the filters and averaging as configured at this point. As discussed above, it is contemplated that DMT application 36 will apply certain filter processes (spike, low flow rate, pressure change) to the data acquired from data sources 2, and will also reduce the amount of data to be processed by way of applying various averaging approaches (daily averages, weekly averages, monthly averages, etc.). In this regard, it is contemplated that web server 32 will provide reservoir engineer RE with configuration options for configuring these filters and averaging transforms.

More specifically, if this model update being processed by DMT application 36 is not the initial update for the reservoir, certain configuration settings regarding the filtering and averaging will have been used in the previous updates, and will have been retained at web server 32. These previous settings can serve as a default value for a first instance of transform process 108 applied to the retrieved historical dataset. This ability to retain and use the previous settings for filters, averaging, and other transform operations, regardless of who previously configured those settings, is useful not only for streamlining the overall processing of these data, but also can assist in the uniformity of the processing applied to wells in the same reservoir over time, and among various reservoir engineers. A given reservoir engineer RE thus need only change these configuration parameters with good cause.

Referring back to FIG. 7d, process 110 is then executed by web server 32 to display the results of transform process 108. These results may be displayed by web server 32 in an interactive fashion, so that reservoir engineer RE can view results by time, by well or wells, by parameter, and with selectable resolution. In this interactive process 110, reservoir engineer RE can modify the transform configuration parameters (e.g., the types and thresholds of one or more of the filters, the desired processing in the event of a measurement caught by one of the filters, the frequency of averaging for one or more measurements, etc.), and then command web server 32 to re-execute transform process 108 on the retrieved data and parameters, but using the new configuration parameters established in process 110. The results are then re-displayed, for further modification by reservoir engineer RE as desired. Following an instance of process 110 in which reservoir engineer RE determines that the transform configuration parameters are as desired, web server 32 then executes process 112 by way of which reservoir engineer RE can analyze the well management hierarchy in order to “roll” the flow rates for each of the wells in the analysis, in the manner known in the art.

Upon completion of process 70, the configuration of the transformation of the acquired measurement data and calculated parameters is complete. Process 72 can then be executed by web server 32, at the command of reservoir engineer RE via workstation 30, to update the observation file (.obs) and to update the rate constraints in the recurrent data file (r.dat) for the active wells for which data and parameters have been processed and calculated, for use by reservoir modeling application 35. In addition, at this point in the process, web server 32 allows reservoir engineer RE to insert various events into the processed model files, such events including timestamps and measurements from RFT tests and perforations performed on the active wells during the time period of interest. In addition, also in process 72, web server 32 allows reservoir engineer to interactively display pressure build-up (PBU) derivatives and corresponding times, and to update the observations file (.obs) as desired. Following process 72, the observations and recurrent data file for the reservoir are updated and complete. Reservoir modeling application 36 may now be executed in the conventional manner, upon the data in the observations file (.obs) and the recurrent data file (r.dat) as processed by DMT application 36.

As shown in FIG. 3, it is contemplated that the execution of reservoir modeling application 35 is typically carried out on a separate computer from web server 32, for example mainframe computer 34. In this case, mainframe computer 34 accesses the processed updated data files produced by DMT application 36 over the network or communications link with web server 32, or more preferably web server 32 stores the processed updated data files produced by DMT application 36 in a memory resource available to mainframe computer 34. Alternatively, web server 32 may itself be the computing resource that executes reservoir modeling application 35 on the processed updated data files produced by DMT application 36. In either case, reservoir engineer RE is able to view the results of the execution of reservoir modeling application 35 via workstation 30, over a network connection or other communications link to the computing resource executing that application.

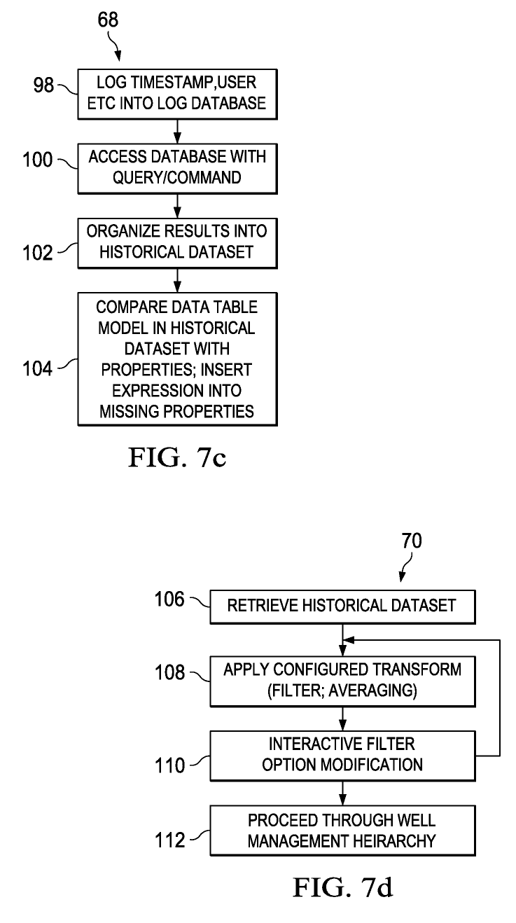

FIG. 8 illustrates an example of the operation of reservoir modeling application 35 in an interactive fashion, as contemplated according to this embodiment of the invention. As described above, the observation file (.obs) and recurrent data file (r.dat) generated from DMT application 36 are applied to reservoir modeling application 35, which executes and updates the current reservoir models according to the data in those applied processed data files. Reservoir modeling application 35 produces an output pred_output, which corresponds to the results of the reservoir model with the new data and calculations. As described above, reservoir engineer RE can display these results at workstation 30, and preferably compares various parameters in the model output pred_output with parameters in the processed data. As shown in FIG. 8, compare process 120a, carried out by reservoir engineer RE via workstation 30, compares one or more parameters from results pred_output generated by reservoir modeling application 35 with corresponding contents measurement_data in the observation file applied to reservoir modeling application 35. These contents measurement_data can include flow rates, pressures, phase information, and the like. Similarly, in compare process 120b, reservoir engineer RE compares various parameters from results pred_output with contents event_data in the recurrent data file applied to reservoir modeling application 35. These contents event_data can include times and measurements from RFT testing (including pressures, fluid samples, and the like acquired through use of a repeat formation tester well tool, as known in the art), and can include measurements and calculations from the analysis of PBU tests, or data from other events. As a result of comparison processes 120a, 120b, reservoir engineer RE can evaluate the manner in which the data and previously calculated parameter values were acquired and processed by DMT application 36, enabling a repetition of that processing or adjustment of the configuration parameters for the next model update process, as desired by the user.

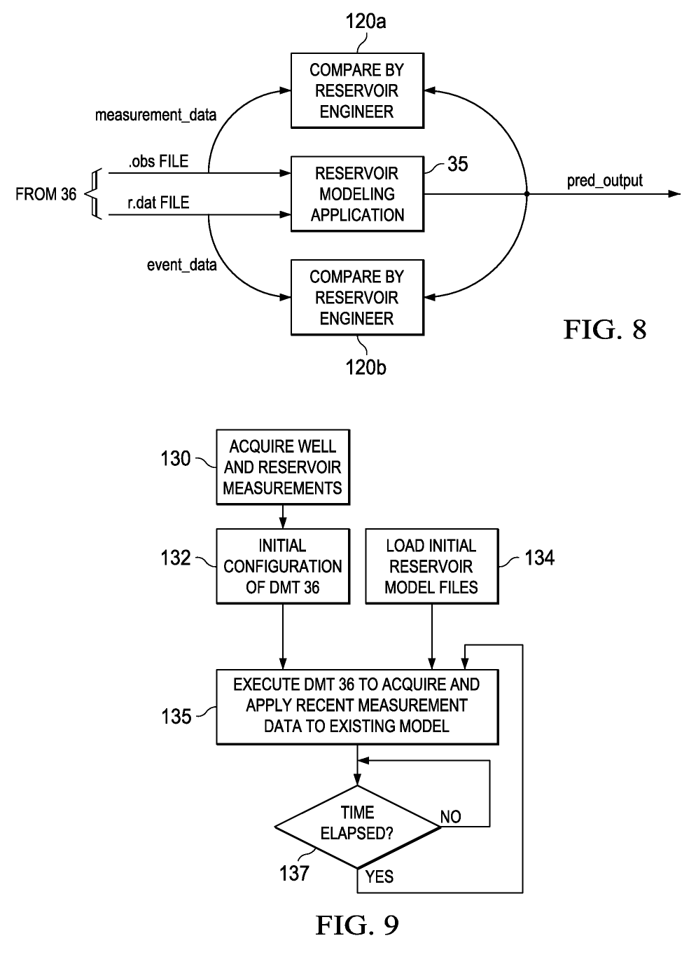

Given this description, it is evident that the updating of reservoir models with newly obtained measurements and calculations is greatly streamlined according to this embodiment of the invention. This streamlining is due, in large part, to the web-based application architecture of data management toolkit (DMT) application 36, and the ability of that application to provide an automated process workflow for the acquiring and processing of such data. In addition, this web-based architecture facilitates the persistent storage of configuration parameters, such that later instances of the acquisition and updating of model files can be readily performed, in a manner consistent with previous instances. FIG. 9 illustrates such a periodic manner of executing DMT application 36 and reservoir modeling application 35, beginning with an initial instance starting with process 130, in which various well and reservoir measurements are obtained over time. For example, given the typical use of reservoir models to determine relatively long-term results, these measurements obtained in process 130 may be taken over a duration of on the order of a few months. In process 132, in advance of the initial execution of DMT application 36, reservoir engineer RE configures DMT application 36 to select the desired time frame of measurement data and calculated values, as well as other configuration parameters such as mapping of data base fields, tags, keys, and columns to corresponding columns and the like of the model files, derivation of the active well list, and establishment of the configuration parameters for filters, averaging, etc.; recurrent data such as RFT, PBU, and other events can also be established. Meanwhile, the initial reservoir model for the wells of interest is loaded in process 134; this initial model may be a true initial model, or may be the results from prior model execution. Then, in this first instance, process 135 is performed, in which DMT application 36 acquires the selected data, processes it according to the configuration parameters, and applies that processed data to the reservoir model files loaded in process 134, in the manner described above. Following this initial instance in process 135, the process is then repeated after a specified time period has elapsed (decision 137), for example after a time period of on the order of one to several months. The repeating of process 135 can be performed at the initiation of a reservoir engineer RE (which may or may not be the same reservoir engineer RE who previously configured DMT application 36), and perhaps at a different workstation 300 which may be in a different geographical location. This repetition of execution process 135 can use some or all of the same configuration parameters as previously selected (with the exception of date range, perhaps), if desired by reservoir engineer RE; on the other hand, certain configuration parameters or selections may be modified in this subsequent instance, for reasons determined by reservoir engineer RE according to his or her expertise. The periodic processing of newly obtained measurements then continues in this manner. Of course, updating of the reservoir models via process 135 may also be performed “on demand”, especially if particular events or reconfiguration of the production field have taken place in the interim.

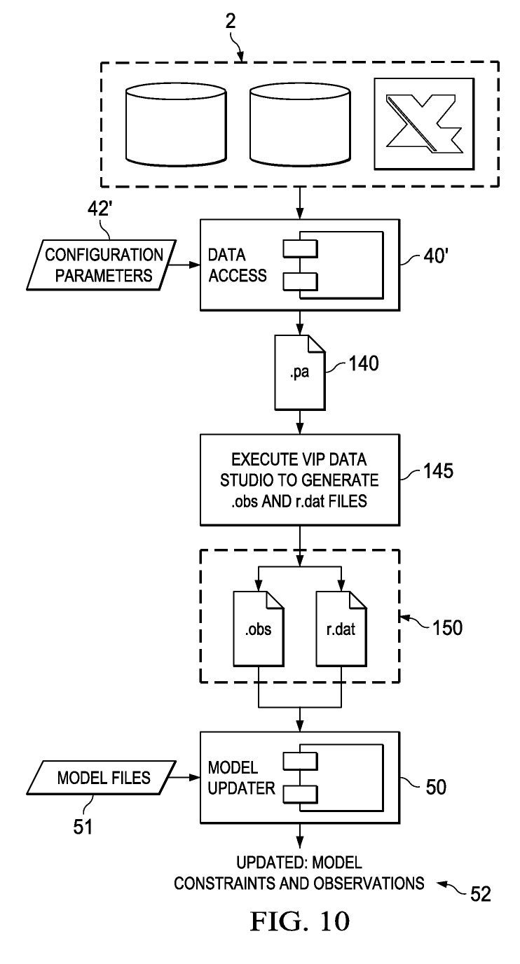

According to this embodiment of the invention as described above, effectively a single application workflow is defined that acquires the desired data, processes that data and transforms it into a format ready for direct application to the reservoir models, as illustrated in FIGS. 4 and 5. This “turnkey” data management approach thus minimizes the workload and intervention of a human expert such as reservoir engineer RE. However, it is also contemplated that this invention may be implemented in a manner that may require the execution of a specific application within the workflow in order to carry out a specific data transformation or reformatting, with the remainder of the workflow handled by the data management toolkit; this “hybrid” style of data management will still benefit from many of the features of the full “turnkey” approach, but may be more efficient to implement in some applications. FIG. 10 provides an example of the workflow of such a hybrid approach, according to an alternative embodiment of the invention, in which the VIP DATA STUDIO application, available from Halliburton as mentioned above, is utilized, by way of example.

In the workflow diagram of FIG. 10, the configuration and operation of data access component 40′, as part of data management toolkit (DMT) application 36 is carried out in a similar manner as that described above, with data access component 40′ configured to pull measurement data such as rate and phase from data sources 2. In this embodiment of the invention, data access component 40′ also includes some of the filtering operations previously contained within transform component 42, including the identification of scenarios such as well “bean-up” events, and also performs spike and low flow rate filtering and spreading of the spike and low flow rate events, based on the configuration parameters 42′ applied to data access component 40′. In this embodiment of the invention, the output of data access component 40′ is a “.pa” file 140, which is compatible as an input file to the VIP DATA STUDIO application, as known in the art. Data access component 40′ resides on and is executed by web server 32, in the form of a web-based application, accessible and interactively cooperating with workstation 30, in the manner described above.

According to this alternative embodiment of the invention, in process 145, reservoir engineer RE executes an application to format the data for application to the model. In this example, the application executed in process 145 is the VIP DATA STUDIO application, by way of which the input .pa file is converted into a pair of files 150, including an observation file .obs and a recurrent data r.dat, as described above. Of course, other applications besides the VIP DATA STUDIO application may alternatively be used, depending on the simulation environment into which this invention is realized. It is contemplated that process 150 may be carried out at workstation 30, for example by web server 32 forwarding the .pa file 140 to workstation 30, at which the VIP DATA STUDIO application resides and is executed, following which the output files 150 are forwarded by workstation 30 to web server 32. Alternatively, the application (VIP DATA STUDIO application in this example) may reside at web server 32 and be executed in the form of a web-based application, if desired.

Files 150 are then applied to model updater component 50, which is arranged as described above relative to FIG. 5, by way of which model files 51 specified by reservoir engineer RE are updated. In general, as discussed above, model updater component 50 reads files 150 as output by the VIP DATA STUDIO application in process 145, inserts PBU simulation results and RFT output commands into the recurrent data file r.dat, converts the data files so that the dates of events indicated in the recurrent data file r.dat are consistent with the time parameters of the PBU analysis and simulation results, and other similar operations. The output of model updater component 50, as above, are data files with model constraints (from recurrent events) and observations (measurements) in a format suitable for the desired reservoir modeling application, such as the TDRM modeling suite. Model updater component 50, as before, preferably resides on and is executed by web server 32, as part of the overall web-based application DMT application 36 described above.

According to this alternative embodiment of the invention, therefore, many of the same advantages are obtained, even though the entire data processing operation is not contained within the same web-based application. Much of the configuration parameter universe can remain persistent at web server 32, and data acquisition and interface to reservoir modeling application 25 can be carried out by web server 32, without involving local workstations except as configuration and display tools, and the execution of an application to carry out data formatting as described above. It is therefore contemplated that this arrangement of FIG. 10 may be preferable, from a deployment standpoint, in some situations in which the overall coding of a turnkey DMT application is not economically beneficial.

This invention, therefore provides numerous advantages in the management of well and reservoir measurement and modeling. A wide range of data sources may now be accessed by a web-based application, and data from those sources can be processed by that web-based application according to configuration parameters that are defined by a human expert, but which can remain persistent at the web server so that consistency of the modeling approach over time, personnel, and location can be maintained as desired. A great deal of flexibility in the processing of these data can be implemented, including variable averaging to minimize the amount of data processed. The software architecture is based on plug-in components, which enables the updating of particular components as desired, and the inclusion of new components, without disrupting the overall application or its operation; indeed, the use of new or updated components can be invoked at run-time. And, according to one embodiment of the invention, the updating of reservoir models can be carried out without requiring an external application for the reformatting and updating of the data files.

While this invention has been described according to one or more of its embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A method of acquiring measurement data for one or more wells and applying data corresponding to that measurement data to a reservoir model, comprising the steps of:
operating a workstation to invoke a software application for execution at a web server;
receiving, at the workstation, configuration inputs comprising an input corresponding to a date range corresponding to measurement data to be acquired, and an input indicating at least one reservoir model file to which the measurement data are to be applied, and forwarding those configuration inputs to the web server;
operating the web server to retrieve measurement data for one or more wells, corresponding to the date range specified in the configuration inputs, from a data server remote from the workstation; and
operating the web server to apply the retrieved measurement data to the at least one reservoir model file specified in the configuration inputs.

2. The method of claim 1, further comprising:
receiving, at the workstation, transform configuration inputs corresponding to processing options; and
after the step of operating the web server to retrieve measurement data, operating the web server to process the retrieved measurement data according to the transform configuration inputs;
wherein the step of operating the web server to apply the retrieved measurement data applies the processed retrieved measurement data to the at least one reservoir model file.

3. The method of claim 2, wherein the transform configuration inputs comprise an input corresponding to a selected spike filter;
wherein the step of operating the web server to process the retrieved measurement data comprises:
processing the retrieved measurement data to apply the selected spike filter to the retrieved measurement data.

4. The method of claim 3, wherein the step of processing the retrieved measurement data to apply the selected spike filter comprises:
excluding one or more measurements identified as excursions from a trend.

5. The method of claim 3, wherein the step of processing the retrieved measurement data to apply the selected spike filter comprises:
spreading one or more measurements, identified as excursions from a trend, over other measurement data for one or more wells.

6. The method of claim 2, wherein the transform configuration inputs comprise an input corresponding to a selected low flow rate filter;
wherein the step of operating the web server to process the retrieved measurement data comprises:
processing the retrieved measurement data to apply the selected low flow filter to the retrieved measurement data.

7. The method of claim 2, wherein the transform configuration inputs comprise an input corresponding to a selected pressure change filter;
wherein the step of operating the web server to process the retrieved measurement data comprises:
processing the measurement data to exclude retrieved measurement data from one or more wells that are determined, by the selected pressure change filter, to exhibit a pressure change in the retrieved measurement data.

8. The method of claim 2, wherein the step of operating the web server to process the retrieved measurement data comprises:
averaging a measurement over a period of time specified in the configuration inputs.

9. The method of claim 2, wherein the transform configuration inputs comprise one or more inputs corresponding to transformation coefficients:
wherein the retrieved measurement data for at least one well correspond to measurements from each of a plurality of layers in the earth at that well;
and wherein the step of operating the web server to process the retrieved measurement data comprises:
transforming the retrieved measurement data corresponding to the plurality of layers, using the transformation coefficients.

10. The method of claim 2, further comprising:
receiving inputs at the workstation to structure a query of a database storing the measurement data;
wherein the step of operating the web server to retrieve measurement data retrieves measurement data according to the structured query.

11. The method of claim 2, wherein the step of operating the web server to process the retrieved measurement data comprises:
filtering the retrieved measurement data according to options specified in the configuration inputs;
interactively communicating with the workstation to display the filtered retrieved measurement data; and
responsive to modified inputs received from the workstation in the interactively communicating step, repeating the filtering step.

12. The method of claim 1, further comprising:
operating the workstation to execute an application on the retrieved measurement data to generate a reformatted version of the retrieved measurement data; and
forwarding the reformatted retrieved measurement data to the web server, prior to the step of operating the web server to apply the retrieved measurement data to the at least one reservoir model file.

13. The method of claim 1, wherein the web server is deployed remotely from the workstation.

14. The method of claim 1, wherein the software application comprises a web-based application.

15. A computer system for acquiring measurement data for one or more wells and applying data corresponding to that measurement data to a reservoir model, comprising:
a data server for storing measurement data acquired from one or more wells over a period of time; and
a web server operable to execute a program perform a plurality of operations comprising:
invoking a software application accessible to a workstation, responsive to a command from the workstation, the workstation remote from the web server;
responsive to a configuration input, received from the workstation via the software application, corresponding to a date range corresponding to measurement data to be acquired, retrieving measurement data from the data server corresponding to the date range; and
responsive to a configuration input, received from the workstation via the software application, indicating at least one reservoir model file to which measurement data are to be applied, applying the retrieved measurement data from the data server to the at least one reservoir model file.

16. The system of claim 15, wherein the plurality of operations further comprises:
after retrieving the measurement data, processing the retrieved measurement data according to transform configuration inputs received from the workstation;
wherein the operation of applying the retrieved measurement data applies the processed retrieved measurement data to the at least one reservoir model file.

17. The system of claim 16, wherein the transform configuration inputs comprise an input corresponding to a selected spike filter;
wherein the operation of processing the retrieved measurement data comprises:
processing the retrieved measurement data to apply the selected spike filter to the retrieved measurement data.

18. The system of claim 16, wherein the transform configuration inputs comprise an input corresponding to a selected low flow rate filter;
wherein the operation of processing the retrieved measurement data comprises:
processing the retrieved measurement data to apply the selected low flow filter to the retrieved measurement data.

19. The system of claim 16, wherein the transform configuration inputs comprise an input corresponding to a selected pressure change filter;
wherein the operation of processing the retrieved measurement data comprises:
processing the measurement data to exclude retrieved measurement data from one or more wells that are determined, by the selected pressure change filter, to exhibit a pressure change in the retrieved measurement data.

20. The system of claim 16, wherein the operation of processing the retrieved measurement data comprises:
averaging a measurement over a period of time specified in the configuration inputs.

21. The system of claim 16, wherein the transform configuration inputs comprise one or more inputs corresponding to transformation coefficients:
wherein the retrieved measurement data for at least one well correspond to measurements from each of a plurality of layers in the earth at that well;
and wherein the operation of processing the retrieved measurement data comprises:
transforming the retrieved measurement data corresponding to the plurality of layers, using the transformation coefficients.

22. The system of claim 16, wherein the operation of retrieving the measurement data retrieves measurement data specified by inputs received from the workstation, via the web-based application, that structure a query of a database storing the measurement data.

23. The system of claim 16, wherein the operation of processing the retrieved measurement data comprises:
filtering the retrieved measurement data according to options specified in the configuration inputs;
interactively communicating with the workstation to display the filtered retrieved measurement data; and
responsive to modified inputs received from the interactive communications with the workstation, repeating the filtering.

24. The system of claim 15, further comprising:
a workstation deployed remotely from the web server and the data server, the workstation for issuing the command to the web server to invoke the web-based application, and to receive the configuration inputs from a user.

25. The system of claim 24, wherein the workstation is operable to execute an application program to perform a plurality of operations comprising:
generating a reformatted version of the retrieved measurement data; and
forwarding the reformatted retrieved measurement data to the web server;
wherein the operation of applying the retrieved measurement data applies the reformatted retrieved measurement data to the at least one reservoir model file.

26. The system of claim 15, wherein the software application comprises a web-based application.
